(19) United States
(12) Patent Application Publication
(10) Pub. No.: US 2023/0151304 A1
(43) Pub. Date: May 18, 2023

(54) ALKALINE DETERGENTS AND METHODS OF CLEANING SHELL EGGS

(71) Applicant: DeLaval Holding AB, Tumba (SE)

(72) Inventors: Fohona S. Coulibaly, Raytown, MO (US); Carolina Mateus, Kansas City, MO (US); Jason T. West, Liberty, MO (US)

(21) Appl. No.: 18/056,278

(22) Filed: Nov. 17, 2022

Related U.S. Application Data
(60) Provisional application No. 63/280,263, filed on Nov. 17, 2021.

(51) Int. Cl. C11D 1/94; C11D 3/04; C11D 3/08; C11D 3/36; C11D 17/00; A23B 5/14; A23B 5/18; A01K 43/00

(52) U.S. Cl. CPC C11D 1/94; A01K 43/005; A23B 5/14; A23B 5/18; C11D 3/08; C11D 3/044; C11D 3/364; C11D 3/365; C11D 17/0043; C11D 1/662

(57) ABSTRACT

Alkaline detergent compositions and methods of using the same for washing of shell eggs are provided that exhibit rapid drying characteristics. The detergent compositions comprise an alkyl polyglucoside surfactant, an alkaline agent, sodium silicate, and water.

### RELATED APPLICATION

The present application claims priority of U.S. Provisional Pat. Application Serial No. 63/280,263 filed on Nov. 17, 2021, and entitled ALKALINE DETERGENTS AND METHODS OF CLEANING SHELL EGGS, which is incorporated by reference herein in its entirety.

### BACKGROUND OF THE INVENTION

### Field of the Invention

Embodiments of the present invention are generally directed toward alkaline detergent compositions comprised of generally recognized as safe (GRAS) components. The detergent compositions are particularly suited for use in the cleaning of shell eggs and exhibit rapid drying characteristics.

### Description of the Prior Art

Since the late 1960s, U.S. egg producers and processors adopted washing and refrigerating their eggs in order to reduce bacterial contamination and spoilage. Partly driven by the success shown in the U.S. egg processing industry and the increase in salmonella cases, egg washing became the norm in Japan in the late 1990s. To date, the washing of table eggs marketed as class A is not permitted in the European Union, although such is permissible for class B eggs. Class A eggs in the E.U. are generally characterized as having a clean, smooth, undamaged shell, have an air space no larger than 6 millimeters, are clear and free from meat and blood spots, have a centrally suspended yolk, do not possess a foul odor, must not contain an embryo, and must be clean. Class B eggs, which can have intact, but dirty, shells are generally broken out and pasteurized prior to use.

In 1966, the USDA published a set of recommendations for cleaning eggs that included:
Do not attempt to clean excessively dirty eggs.
Avoid the use of wash water containing more than 2 ppm of iron.
Do not recirculate the wash water.
Use odorless cleaning materials.
Wash eggs as soon as practical after they are laid.
Maintain wash water at a temperature that is at least 20° F. (~11° C.) higher than that of the eggs through all washing operations (wetting, cleaning, and rinsing).
Moisten eggs with stained shells and adhering dirt before eggs are submitted to cutting-spray wash and brushes.
Have a water spray with sufficient force to cut away loose dirt before brushing.
Use abrasive materials in bristles to increase the abrasive power of ordinary brushes.
Maintain an accurate control of the sanitizer-detergent level within the wash water.
Use a final rinse for the washed eggs.
Dry wash eggs completely before packing them.

Evidence has been generated previously showing a correlation between the high pH (pH≥10.5) of the egg washing solution and the low count of aerobic bacteria in egg wash water sampled from several commercial egg washing facilities. Therefore, many conventional egg wash solutions are formulated to be alkaline. While egg washing appears beneficial from the standpoint of bacteria control, complete drying of eggs after washing has proven challenging. Complete drying becomes even more critical when shell eggs are graded and stamped. In fact, egg grading machines, which utilize cameras to visually inspect the eggs, tend to return wet eggs into the washing process when they show a wet spot. This in turn increases the number of the so called “dirties,” and the likelihood of eggs breaking in the washing process.

Therefore, a need exists in the art for an alkaline detergent composition that allows both adequate cleaning and the complete and rapid drying of shell eggs that avoids rewashing of eggs, the associated likelihood of accidental egg breakage and eventual interruptions to the grading process.

### SUMMARY OF THE INVENTION

According to one embodiment of the present invention there is provided a detergent composition comprising an alkyl polyglucoside surfactant, an alkaline agent, sodium silicate, and water.

According to another embodiment of the present invention there is provided a detergent composition comprising from about 0.075% to about 1% by weight of an alkyl polyglucoside surfactant; from about 5% to about 50% by weight of an alkaline agent; from about 0.15% to about 5% by weight of an alkali metal silicate (e.g. sodium silicate, potassium silicate); and from about 40% to about 80% by weight of water.

According to another embodiment of the present invention there is provided a wash solution formulated from a detergent composition prepared according to any embodiment of the present invention. According to a particular embodiment, the wash solution is prepared by mixing 1 part of the detergent composition with 50 to 300 parts by volume water.

According to yet another embodiment of the present invention there is provided method of cleaning shell eggs. The method comprises wetting the shells of the eggs, applying a wash solution according to any embodiment of the present invention to the shells of the eggs, rinsing the shells of the eggs to remove the wash solution, and drying the shells of the eggs.

### DETAILED DESCRIPTION OF THE PREFERRED EMBODIMENT

Detergent compositions for washing shell eggs and methods of washing shell eggs are described herein. Embodiments of the present invention facilitate rapid cleaning and drying of the shells of the eggs so that the eggs can be further processed and not rejected from the processing line, thus reducing the number of the so called “dirties”.

In one or more embodiments, the detergent compositions are responsible, at least in part, for ensuring complete drying of the shells following the washing process. In order to avoid being rejected, the eggshells should not possess optically detectable wet spots, which would cause the egg to be rejected as “dirty” and sent back for rewashing. Further, complete drying of the shells permits proper stamping of the eggshell (with a food-grade ink), as desired.

The detergent compositions are preferably alkaline possessing a pH that is greater than 7, greater than 8, greater than 9, greater than 10, greater than 11, or greater than 12. Alternatively, the detergent composition has a pH from about 9 to about 13.5, from about 10.5 to about 13, or from about 11.5 to about 12.5. The desired pH is achieved through the presence of an alkaline agent, such as an alkali metal hydroxide, and particularly potassium hydroxide and/or sodium hydroxide. The alkaline agent may be present within the detergent composition in an amount of at least 5% by weight, based upon the entire weight of the composition. In preferred embodiments, the alkaline agent is present within the detergent composition in an amount from about 5% to about 50% by weight, from about 15% to about 45% by weight, or from about 25% to about 35% by weight.

In one or more embodiments, the detergent composition is formulated with a low foaming and alkaline stable surfactant to provide adequate wetting of the cleaning solution onto the surface of the eggs as well as to provide soil suspension during the cleaning process. Preferably, the detergent composition comprises an alkyl polyglucoside (APG) surfactant. Preferred APG surfactants comprise a carbon chain ranging C₆-C₁₆, with C6 alkyl polyglucoside surfactants being particularly preferred. AG 6206 from Nouryon is an exemplary APG surfactant. In one or more embodiments, the APG surfactant is present within the detergent composition in an amount from about 0.075% to about 1% by weight, from about 0.1% to about 0.75% by weight, or from about 0.15% to about 0.5% by weight.

In one or more embodiments, the detergent composition comprises an alkali metal silicate such as sodium silicate, also referred to as water glass. Sodium silicate is a generic term for chemical compounds having the formula Na₂ₓ-Si_{y}O_{2y+x} or (Na₂O)ₓ (SiO₂)_{y}, such as sodium metasilicate, sodium orthosilicate, and sodium pyrosilicate. In certain embodiments, the sodium silicate promotes drying of the eggshells and facilitates better cleaning of the equipment used for the egg washing process. The sodium silicate is present within the detergent composition in an amount from about 0.015% to about 5% by weight, from about 0.2% to about 1.5% by weight, or from about 0.5% to about 1.2% by weight.

Detergent compositions according to the present invention may further comprise additional components such as water softeners and chelating agents. In one or more embodiments, the detergent composition includes a water softener, and particularly a phosphonate compound. Preferred phosphonate compounds include aminotris(methylene phosphonic acid) pentasodium salt (ATMP 5Na) and aminotris(methylenephosphonic acid) (ATMP). The water softener may be present within the detergent composition in an amount from 0% to about 5% by weight, from about 0.1% to about 2.5% by weight, or from 0.5% to about 1% by weight.

In one or more embodiments, the detergent composition comprises a chelating agent capable of sequestering iron ions present in the egg wash solution, as elevated iron levels can adversely impact the quality of the eggshells. Exemplary chelating agents that may be used include alkaline stable chelating agent selected from the group consisting of gluconic acid, sodium gluconate, diethylenetriaminepentaacetic acid, ethylenediaminetetraacetic acid, nitrilotriacetic acid (NTA), and tripolyphosphate (TPP) sodium salts. The chelating agent may be present within the detergent composition in an amount from 0% to about 7.5% by weight, from about 1% to about 5% by weight, or from about 2% to about 4% by weight.

In one or more embodiments, the choice of components, and in particular the surfactants, provide for a low-foaming detergent composition. Thus, the need for an additional defoaming agent is avoided. Accordingly, certain embodiments of the present invention do not comprise a defoaming agent. However, if the detergent composition is formulated with surfactants that produce higher foaming characteristics, defoaming agents can be included in the formulation.

In one or more embodiments, the balance of the detergent composition comprises water in an amount from about 40% to about 80% by weight, from about 50% to about 70% by weight, or from about 55% to about 65% by weight.

The detergent compositions can be diluted with water to form a wash solution that can be applied to the eggs during an egg washing process. In one or more embodiments, the wash solution is prepared so as to comprise 1 part by volume of the detergent composition, according to any embodiment described herein, and from about 50 to about 300, from about 150 to about 280, or from about 200 to about 260 parts by volume water. In certain embodiments, the wash solution has a pH from about 10.5 to about 13, from about 11.5 to about 12.75, or from about 12 to about 12.5.

Table 1, below, summarizes exemplary detergent compositions made in accordance with the present invention.

TABLE 1

Detergent compositions

| Component | Broad (wt. %) | Preferred (wt. %) | Most preferred (wt. %) |
|---|---|---|---|
| Water | 40-80% | 50-70% | 55-65% |
| Alkaline agent | 5-50% | 15-45% | 25-35% |
| Alkyl polyglucoside surfactant | 0.075-1% | 0.1-0.75% | 0.15-0.5% |
| Sodium silicate | 0.15-5% | 0.2-1.5% | 0.5-1.2% |
| Water softener | 0-5% | 0.1-2.5% | 0.5-1% |
| Chelating agent | 0-7.5% | 1-5% | 2-4% |

Table 2, below, summarizes exemplary wash solutions made through dilution of the detergent compositions with water.

TABLE 2

Wash solutions

| Component | Broad (wt. %) | Preferred (wt. %) | Most preferred (wt. %) |
|---|---|---|---|
| Water | 98.06145-99.97536% | 98.45057-99.92265% | 98.81989-99.86722% |
| Alkaline agent | 0.02358-1.415% | 0.07075-1.2735% | 0.11792-0.9905% |
| Alkyl polyglucoside surfactant | 0.00035-0.0283% | 0.00047-0.02123% | 0.00071-0.01415% |
| Sodium silicate | 0.00071-0.1415% | 0.00094-0.04245% | 0.00236-0.03396% |
| Water softener | 0-0.1415% | 0.00047-0.07075% | 0.00236-0.0283% |
| Chelating agent | 0-0.21225% | 0.00472-0.1415% | 0.00943-0.1132% |

The detergent compositions can be used in methods of cleaning shell eggs, especially through dilution to form wash solutions. In one embodiment, the washing process begins by wetting the shells of the eggs. Note, this is a preferred step, but the wetting step should not be viewed as required of all embodiments. Particularly, water having a temperature from about 90° F. to about 120° F., from about 95° F. to about 115° F., or from about 100° F. to about 110° F. is applied to the shells in order to wet all, or substantially all, of the shell outer surface. The wetting step may be performed by spraying or dripping the eggs with water. In preferred embodiments, the eggs are loaded into a wire basket or other similar device and sprayed with water for a period of less than 10 seconds, less than 8 seconds, or less than 5 seconds.

Next, a wash solution prepared from the detergent composition is applied to the shells of the eggs. Preferably, the detergent composition is diluted with water to form the wash solution. A preferred dilution ratio is to mix 0.5 oz of detergent with one gallon of water, although other dilution ratios may be used as desired for a particular application. The methods of application can be similar to that of the wetting step, although, the same method used to wet the eggs does not need to be employed during the washing step. In a preferred embodiment; however, the wash solution is applied by spraying. In another embodiment, the washing step is performed without the eggshells contacting brushes. During application to the shells, the wash solution has a temperature from about 90° F. to about 120° F., from about 95° F. to about 115° F., or from about 100° F. to about 110° F. In one or more embodiments, the wash solution is applied to the shells of the eggs for a period from about 10 seconds to about 60 seconds, from about 15 seconds to about 50 seconds, from about 20 seconds to about 40 seconds, or about 30 seconds. In one or more embodiments, the wash solution is recirculated within the cleaning apparatus. This is in contrast to the original USDA guidelines advising against recirculation of the wash water.

Following the washing step, the shells are rinsed to remove the wash solution and any remaining loose soils. In one or more embodiments, the rinsing step comprises applying water to the shells of the eggs. Preferably, the rinse water has a temperature from about 90° F. to about 120° F., from about 95° F. to about 115° F., or from about 100° F. to about 110° F. The rinse water can be applied using any application method similar to the wetting step, with spraying being a preferred method of application. The rinsing step is preferably carried out for a period of less than 30 seconds, less than 20 seconds, or less than 15 seconds.

The shells of the eggs are then dried. The drying step can be as simple as permitting the eggs to air dry. In certain embodiments, the detergent compositions are responsible for a significantly lower egg wash solution surface tension. Not only does this help shed water from the eggshells, but the water forms smaller, thinner droplets, which promotes drying. However, in particular embodiments, it is preferred to provide forced-air drying of the eggs in the drying step. The forced-air drying comprises passing a stream of air over the surface of the shells generated by a fan, a blower or similar apparatus. The air stream can be provided at ambient temperature or heated. Preferably, the air stream, if heated, is provided at a temperature of about 90° F. to about 120° F., from about 95° F. to about 115° F., or from about 100° F. to about 110° F. In one or more embodiments, the step of drying the shells of the eggs is carried out for a period of less than 15 seconds, less than 12 seconds, less than 10 seconds or less than 8 seconds. Moreover, within this time period at least 90%, at least 95%, or at least 98% of the eggs are completely dried. Thus, less than 10%, less than 5%, or less than 2% of the eggs, upon immediate visual inspection, are rejected as “dirty” due to the presence of wet spots on the shells and sent for rewashing.

### EXAMPLES

The following examples set forth detergent formulations in accordance with embodiments of the present invention, along with comparative formulations. It is to be understood, however, that these examples are provided by way of illustration and nothing therein should be taken as a limitation upon the overall scope of the invention.

Table 3 sets forth various detergent formulations that were prepared and tested to determine their suitability in forming egg wash solutions. The detergents were formulated and then diluted with water at a level of 0.5 oz/gal to form the egg wash solutions. The eggs were then subjected to the following egg washing procedure.

Eight freshly laid eggs were placed into a wire basket and wetting with tap water at a temperature from 100° F. to 110° F. for 5 seconds using a spraying assembly comprising a plurality of spray nozzles. The wash solution was prepared by diluting each formulation in tap water at a temperature from 100° F. to 110° F. The eggs were washed by spraying them with the wash solution for 30 seconds. The eggs were then rinsed with tap water at a temperature from 100° F. to 110° F. for 15 seconds. The eggs were then blow-dried with a fan and the total time to dry all eggs was recorded using a timer. The eggs were then visually inspected for cleanliness.

TABLE 3

| Formula Ingredients | Formulations | | | | | | | | |
|---|---|---|---|---|---|---|---|---|---|
| | F1 | F2 | F3 | F4 | F5 | F6 | F7 | F8 | F9 |
| NaOH | 20 | 20 | 0 | 0 | 0 | 0 | 0 | 40 | 35 |
| KOH | 0 | 0 | 31.5 | 29.25 | 11.25 | 31.5 | 31.5 | 0 | 0 |
| Sodium hypochlorite | 0 | 0 | 0 | 0 | 3.125 | 0 | 0 | 0 | 0 |
| C6 Alkyl polyglucoside | 0 | 0 | 0 | 0 | 0 | 0 | 0.1875 | 0.1875 | 0.1875 |
| C8 Alkyl polyglucoside | 0.975 | 0 | 0.325 | 0.325 | 0 | 0 | 0 | 0 | 0 |
| Alkyl etherhydroxypropyl sultaine | 0 | 1.425 | 0 | 0 | 0 | 0.2375 | 0 | 0 | 0 |
| Octyl dimethyl amine oxide | 0 | 0 | 0 | 0 | 0.075 | 0 | 0 | 0 | 0 |
| Sodium Xylene Sulfonate | 0.6 | 0.6 | 0 | 0 | 0 | 0 | 0 | 0 | 0 |
| ATMP 5Na | 0.8 | 0.8 | 0.72 | 0.72 | 0 | 0.72 | 0.72 | 0.72 | 0.72 |
| Maleic anhydride, phosphate sodium salts | 0 | 0 | 0 | 0 | 5 | 0 | 0 | 0 | 0 |
| 2-Phosphonobutane-1,2,4-tricarboxylic acid tetra sodium salt | 0 | 0 | 0 | 0 | 2.5 | 0 | 0 | 0 | 0 |
| Gluconic acid | 2 | 2 | 3.25 | 3.25 | 0 | 3.25 | 3.25 | 3.25 | 3.25 |
| Sodium Silicate | 0.1915 | 0.1915 | 0.766 | 0.766 | 0 | 0.766 | 0.766 | 0.766 | 0.766 |
| Cacamidopropyl betaine | 1.8 | 1.8 | 0.15 | 0.15 | 0 | 0.075 | 0 | 0 | 0 |
| water | 73.6335 | 73.1835 | 63.289 | 65.539 | 78.05 | 63.4515 | 63.5765 | 55.0765 | 60.0765 |
| Total % | 100 | 100 | 100 | 100 | 100 | 100 | 100 | 100 | 100 |
| pH (0.5 oz/gal solution) | 12.06 | 12.15 | 12.18 | 12.22 | 11.69 | 12.2 | 12.23 | 12.31 | 12.27 |
| Egg dry time (seconds) | 23 | 24 | 29 | 21 | 27 | 22 | <8 | <8 | <8 |
| NaOH | | | | 35 | 35 | 35 | 35 | 35 | 35 |
| KOH | | | | 0 | 0 | 0 | 0 | 0 | 0 |
| Sodium hypochlorite | | | | 0 | 0 | 0 | 0 | 0 | 0 |
| C6 Alkyl glucoside | | | | 0.375 | 0.375 | 0 | 0 | 0 | 0.1875 |
| C8 Alkyl glucoside | | | | 0 | 0 | 0 | 0 | 0 | 0 |
| Alkyl etherhydroxypropyl sultaine | | | | 0 | 0 | 0 | 0 | 0 | 0 |
| Octyl dimethyl amine oxide | | | | 0 | 0 | 0 | 0 | 0 | 0 |
| Sodium Xylene Sulfonate | | | | 0 | 0 | 0 | 0 | 0 | 0 |
| ATMP 5Na | | | | 0.72 | 0.72 | 0.72 | 0.72 | 0.72 | 0.72 |
| Maleic anhydride, phosphate sodium salts | | | | 0 | 0 | 0 | 0 | 0 | 0 |
| 2-Phosphonobutane-1,2,4-tricarboxylic acid tetra sodium salt | | | | 0 | 0 | 0 | 0 | 0 | 0 |
| Gluconic acid | | | | 3.25 | 3.25 | 3.25 | 3.25 | 3.25 | 3.25 |
| Sodium Silicate | | | | 0 | 1.532 | 0 | 1.532 | 0.766 | 0 |
| Cacamidopropyl betaine | | | | 0 | 0 | 0 | 0 | 0 | 0 |
| water | | | | 60.655 | 59.123 | 61.03 | 59.498 | 60.264 | 60.8425 |
| Total % | | | | 100 | 100 | 100 | 100 | 100 | 100 |
| pH (0.5 oz/gal solution) | | | | 12.23 | 12.24 | 12.19 | 12.27 | 12.17 | 12.37 |
| Egg dry time (seconds) | | | | 30 | 14 | 20 | 50 | 45 | 43 |

Detergent compositions F7-F9 all performed acceptably well, giving drying times of less than 8 seconds. An advantage is observed between these formulations and F1, which used a C8 APG. Not only did the C6 APG formulations (F7-F9) dry faster, they did so with less surfactant. F2, F5, and F6, all formulated without an APG surfactant, performed similarly to F1. F3 and F4 demonstrated that replacing some of the C8 APG with additional sodium silicate, did not result in any significant improvement in drying performance.

Compositions F10-F15 establish that a synergy exists for formulations employing both a C6 APG and sodium silicate. F11 was the only formulation of this set to comprise both the C6 APG and sodium silicate. As can be seen, it exhibited the shortest drying time of any other of the formulations of this set. However, the amount of C6 APG used was roughly double that of formulations F7-F9. Surprisingly, the drying time for F11 was higher than for F7-F9. This observation could be attributable to the increased amount of surfactant forming a film on the eggshells.

F10 and F15 demonstrate the adverse impact on drying time when no sodium silicate is present, despite the same or higher level of C6 APG being used. These results are compared with F12, in which no AGP or sodium silicate is present. Quite surprisingly, F12 has a shorter drying time than F10 and F15.

I claim:

1. A detergent composition comprising:
from about 0.075% to about 1% by weight of an alkyl polyglucoside surfactant;
from about 5% to about 50% by weight of an alkaline agent;
from about 0.15% to about 5% by weight of an alkali metal silicate; and
from about 40% to about 80% by weight of water.

2. The detergent composition of claim 1, wherein the alkyl polyglucoside surfactant comprises a C6-C16 alkyl polyglucoside surfactant.

3. The detergent composition of claim 2, wherein the alkyl polyglucoside surfactant comprises a C6 alkyl polyglucoside surfactant.

4. The detergent composition of claim 1, wherein the alkaline agent comprises NaOH and/or KOH.

5. The detergent composition of claim 1, wherein the composition further comprises from about 0.1% to about 2.5% by weight of a water softener.

6. The detergent composition of claim 5, wherein the water softener comprises a phosphonate compound.

7. The detergent composition of claim 1, wherein the composition comprises from about 1% to about 5% by weight of a chelating agent.

8. The detergent composition of claim 7, wherein the chelating agent comprises an alkaline stable chelating agent selected from the group consisting of gluconic acid, sodium gluconate, diethylenetriaminepentaacetic acid, ethylene-diaminetetraacetic acid, nitrilotriacetic acid (NTA), and tripolyphosphate (TPP) sodium salts.

9. The detergent composition of claim 1, wherein the detergent composition comprises:
from about 0.15% to about 0.5% by weight of the alkyl polyglucoside surfactant,
wherein the alkyl polyglucoside surfactant is a C6 alkyl polyglucoside surfactant;
from about 25% to about 35% by weight of the alkaline agent, wherein the alkaline agent is NaOH and/or KOH;
from about 0.5% to about 1.2% by weight of the alkali metal silicate; and
from about 55% to about 65% by weight of water.

10. A wash solution comprising 1 part by volume of the detergent composition according to claim 1 and from 50 to 300 parts by volume water.

11. The wash solution of claim 1, wherein the wash solution has a pH from about 10.5 to about 13.

12. A method of cleaning shell eggs comprising:
wetting the shells of the eggs;
applying a wash solution according to claim 10 to the shells of the eggs;
rinsing the shells of the eggs to remove the wash solution; and
drying the shells of the eggs.

13. The method of claim 12, wherein the step of wetting the shells of the eggs comprises applying to the shells water having a temperature from about 90° F. to about 120° F.

14. The method of claim 13, wherein the water is applied to the shells by spraying.

15. The method of claim 13, wherein the wetting step is carried out for a period of less than 10 seconds.

16. The method of claim 12, wherein the wash solution has a temperature from about 90° F. to about 120° F.

17. The method of claim 16, wherein the wash solution is applied to the shells of the eggs for a period from about 10 seconds to about 60 seconds.

18. The method of claim 12, wherein the step of rinsing the shells of the eggs comprises applying water having a temperature from about 90° F. to about 120° F. to the shells.

19. The method of claim 18, wherein the step of rinsing the shells of the eggs is carried out for a period of less than 30 seconds.

20. The method of claim 12, wherein the step of drying the shells of the eggs comprises forced-air drying of the eggs.

21. The method of claim 20, wherein the step of drying the shells of the eggs is carried out for a period of less than 15 seconds.

22. The method of claim 21, wherein at least 90% of the eggs are completely dried within the drying step period.
